(19) United States
(12) Patent Application Publication
(10) Pub. No.: US 2004/0216098 A1
(43) Pub. Date: Oct. 28, 2004

(54) Scalable agent service scheduler

(76) Inventors: Colleen A. Roe, Hillsboro, OR (US); Sergio Gonik, Portland, OR (US)

Correspondence Address: IPSOLON LLP, 805 SW BROADWAY, #2740, PORTLAND, OR, 97205, US

(21) Appl. No.: 10/067,677

(22) Filed: Feb. 4, 2002

Related U.S. Application Data
(60) Provisional application No. 60/266,569, filed on Feb. 5, 2001.

(51) Int. Cl. G06F 9/45; G06F 9/00

(52) U.S. Cl. 717/161; 718/102; 718/104

(57) ABSTRACT

A scalable agent service system supports a scalable, arbitrary number of computer software agents for providing services and information to a scalable, arbitrary number of user or client computation devices. The user computation devices may be of virtually any form, including personal or laptop computers, handheld computing or digital organizer devices, digital cellular telephones, etc. The scalable agent service system obtains information (i.e., data or “events”) from and operates in response to one or more external data feeds, at least some of which provide real-time data. The software agents evaluate the events received from the data feeds against predefined rules (i.e., detecting events of interest) to determine one or more appropriate responsive actions. The scalable agent service system can accommodate services having various timing characteristics, whether periodic, spontaneous, or non-periodic scheduled. Accordingly, one implementation includes a scalable agent service scheduling system that includes an isochronal scheduler of future event services.

### FIELD OF THE INVENTION

The present invention relates to software systems for providing arbitrary services to users and, in particular, to a scalable agent service system that supports an arbitrary number of computer software agents for providing services or information to an arbitrary number of client computation or communication devices.

### BACKGROUND AND SUMMARY OF THE INVENTION

Conventional large-scale computing services are typically adapted to the enterprise providing the services. Such enterprise centric computing is typically directed to a relatively narrow range of services (e.g., a database with a particular type of information). An example of an enterprise centric computing service is a travel or airline ticketing service that allows users to search for and purchase travel-related services. Another example of an enterprise centric computing service is an online retailer that allows users to search for and purchase particular goods. A limitation of enterprise centric computing is that it commonly fails to serve various needs and preferences of each user. In contrast to enterprise centric computing, user centric computing is typically obtained by users piecing together a variety of independent and separate services.

It is believed that the current absence of large scale user centric computing stems from a lack of a scalable architecture for user-centric computing. Conventional architectural arrangements, such as instantiating and running a separate agent for each user of the system or having a single agent to serve all users, suffer from severe scalability limitations. In the absence of a scalable implementation for user centric computing that can accommodate many thousands, or even millions of users, users have been limited to use of various enterprise centric computing services.

The present invention includes a scalable agent service system that supports a scalable, arbitrary number of computer software agents for providing services and information to a scalable, arbitrary number of user or client computation devices. The user computation devices may be of virtually any form, including personal or laptop computers, handheld computing or digital organizer devices, digital cellular telephones, etc.

A generalized aspect of the scalable agent service system is that it obtains information (i.e., data or “events”) from and operates in response to one or more external data feeds, at least some of which provide real-time data. In particular, the software agents evaluate the events received from the data feeds against predefined rules (i.e., detecting events of interest) to determine one or more appropriate responsive actions. (In artificial intelligence systems, such operation of the agents would sometimes be referred to as “inferencing.”) As examples, the actions taken by the agents might involve contacting a user and supplying timely information or interacting with the user or some other system to carry out a transaction. Accordingly, another aspect of the scalable agent service system and its agents is that they operate by detecting events, correlating events, and generating events (e.g., responding by delivering a service).

In one implementation, the scalable agent service system has an architecture that includes an inferencing or reasoning portion referred to as an adaptive engine and an action or event execution portion referred to as a service fulfillment engine. The adaptive engine communicates with the service fulfillment engine by passing one or more tasks that specify one or more actions that to be fulfilled by service fulfillment engine. This permits the adaptive engine and the service fulfillment engine to asynchronously identify and process events and actions. In particular, the adaptive engine identifies the tasks that need to be done, and the service fulfillment engine performs the actions required to complete the tasks.

This architecture partitions the reasoning or inferencing operation of adaptive engine from the service fulfillment (action/execution) operation of service fulfillment engine. The partitioning allows the adaptive engine to use general analysis techniques or inferencing (e.g., artificial intelligence) independently of the distinct, possibly more mundane computational techniques (e.g., FTP to deliver a file, SMS messaging to a cell phone, etc.) that the service fulfillment engine may use to execute its tasks. The architectural arrangement of the adaptive engine and the service fulfillment engine is scalable to large numbers of users (e.g., many thousands, or even millions). In particular, the partition between the adaptive engine and the service fulfillment engine allows them to operate simultaneously and independently.

Another aspect of the scalable agent service system of the present invention is its ability to accommodate services having various timing characteristics, whether periodic, spontaneous, or non-periodic scheduled. Accordingly, one implementation includes a scalable agent service scheduling system that includes an isochronal scheduler of future event services.

The isochronal scheduler may include an isochronal table of multiple activation times at which service events can be activated, the isochronal table including a predefined time interval between each of the successive activation times. In operation, the isochronal scheduler may pass as a batch all service events for each activation time to a service event queue. A dispatcher of current service events may retrieve service events from the service event queue and acquire and launch service agents to service the various service events. The scalable agent service scheduling system can provide scalable and efficient handling of periodic, spontaneous, or non-periodic scheduled event services.

The scalable agent service system of the present invention can be hosted on an ASP (application service provider) site and is capable of providing a wide range of services to, and using a wide range of agents for, an arbitrary number of users. One example includes a financial assistant agent that is constantly supplied information by data feeds for stocks, futures, securities, etc. The agent continuously reviews the information provided by the data feeds to identify events indicated by a user to be of interest (e.g., providing the user with immediate notification when a certain stock has reached a predefined price). The agent could communicate with the user via mobile technology such as SMS (short message service) messaging on a cellular telephone. In one implementation, the financial assistant agent could even carry out financial transactions it has been preauthorized to execute.

Such an agent could contain a comprehensive profile of the user's investments, interests, travel plans, schedule, etc. The agent might orchestrate interactions with a network of other agents and delegate work to them while exchanging only the critical pieces of the user profile needed to carry out the work.

The present invention provides a scalable agent service system with an architecture that can support a scalable, arbitrary number of computer software agents for providing services and information to a scalable, arbitrary number of user or client computation devices. The scalable agent service system can support large-scale user centric computing that can provide a range of computer services that are selectable and adaptable by users. While some of the services may be analogous to currently available user software services, the partitioning and asynchronicity in the generalized architecture of the present invention allow a variety of current and new services to be provided in a scalable manner to arbitrary numbers of users.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a simplified block diagram of a scalable agent software system.

FIG. 2 is an illustration of a classification or taxonomy of the types of events accommodated by the agent software system of FIG. 1.

FIG. 3 is a block diagram generally illustrating an internal architecture of the scalable agent software system.

FIG. 4 is a block diagram of one implementation of an internal architecture of an adaptive engine included in the scalable agent software system.

FIG. 5 is a block diagram of one implementation of an internal architecture of a service fulfillment engine included in the scalable agent software system.

FIGS. 6 and 7 illustrate as a process flow operation of the scalable agent software system to service an exemplary scheduled event.

FIG. 8 is a flow diagram of a system partitioning method that uses a combination of partitioning-for-concurrency and pooling paradigms.

FIG. 9 is a flow diagram of a batched processing method that utilizes slightly relaxed immediacy constraints.

FIG. 10 is a flow diagram of an isochronal scheduling method.

FIG. 11 is a schematic illustration of an isochronal mapping.

FIG. 12 is a flow diagram of an appointment management method for managing appointment events.

### DETAILED DESCRIPTION OF PREFERRED EMBODIMENTS

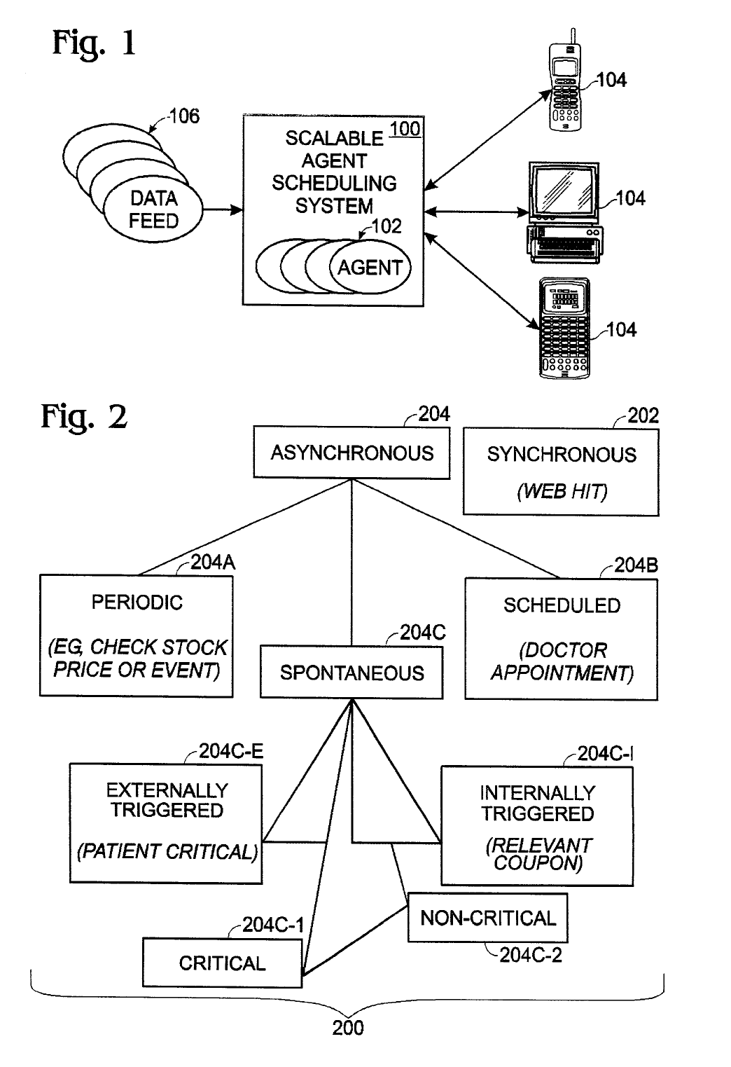

FIG. 1 is a simplified block diagram of a scalable agent service system 100 that supports a scalable, arbitrary number of computer software adaptive agents 102 for providing services and information to a scalable, arbitrary number of user or client computation devices 104. User computation devices 104 may be of virtually any form, including personal or laptop computers, handheld computing or digital organizer devices, digital cellular telephones, etc. As described below in greater detail, scalable agent service system 100 and adaptive agents 102 may be implemented as one or more methods by computer software instructions that are stored on a computer readable medium and executed by client or server computer devices.

A generalized aspect of scalable agent service system 100 is that it obtains information (i.e., data or “events”) from and operates in response to one or more external data feeds 106, at least some of which provide real-time data. In particular, adaptive agents 102 evaluate the events received from data feeds 106 against predefined rules (i.e., detecting events of interest) to determine one or more appropriate responsive actions. (In artificial intelligence systems, such operation of adaptive agents 102 would sometimes be referred to as “inferencing.”) As examples, the actions taken by adaptive agents 102 might involve contacting a user and supplying timely information or interacting with the user or some other system to carry out a transaction. Accordingly, another aspect of scalable agent service system 100 and adaptive agents 102 is that they operate by detecting events, correlating events, and generating events (e.g., responding by delivering a service).

Adaptive agents 102 may be characterized as being “long-lived”, “semi-autonomous”, “proactive”, and “adaptive”. Adaptive agents 102 are long lived because they act continuously on behalf of users, sometimes day in, day out. In contrast is a spreadsheet that is worked on for a while and then closed down. Adaptive agents 102 are semi-autonomous because they sometimes take actions on a user's behalf without first acquiring direct user permission. Adaptive agents 102 are proactive because they can take actions to preclude problems. Adaptive agents 102 are adaptive because they can take actions in the face of uncertainty or “gray” information. Unlike conventional software systems, adaptive agents 102 can function even in the face of missing or contaminated information.

FIG. 2 is an illustration of a classification or taxonomy 200 of the types of events accommodated by scalable agent service system 100. The event types illustrated in FIG. 2 correspond to events that may arise from sources external to scalable agent service system 100, such as an events detected from data feeds 106, or may arise from internal sources, such as events generated internally by an adaptive agent 102.

A fundamental distinction is whether an event is of a synchronous event 202 or an asynchronous event 204. Synchronous events 202 “enter” scalable agent service system 100, whether from internal or external sources, and require synchronous or generally instantaneous responses. As an example, the accessing of a network site on the World Wide Web portion of the Internet, and the returned information (i.e., a Web page hit) is a synchronous event 202 that enters scalable agent service system 100 from an external source and requires a generally instantaneous response to conform with the HTTP protocol used by the World Wide Web.

Asynchronous events 204 are free of the instantaneous response requirements of synchronous events 202. Asynchronous events 204 enter scalable agent service system 100, whether from internal or external sources, and are responded to in a non-instantaneous manner. Asynchronous events 204 may be further categorized as periodic events 204A, scheduled events 204B, and spontaneous events 204C.

Periodic events 204A occur repeatedly over some period of time. Consider the example of a financial assistant or agent 102 that is constantly monitoring a financial data feed 106 relating to equity stock prices, for example. If such a data feed 106 were of a data pull-type (as opposed to a data push-type), the financial assistant or agent 102 would have to schedule regular, periodic internal events to trigger the pull or retrieval of data from the data feed 106.

Scheduled events 204B are external events (like a user's appointment with a doctor) that need to be recognized by an adaptive agent 102 and acted on in a timely fashion.

Spontaneous events 204C can be either internally triggered (204C-I) or externally triggered (204C-E). The detection of a major stock price change by inferencing on information supplied by a data feed 106 is an example of an externally triggered event. An internally triggered event might be generated by an adaptive agent 102 when it recognizes that a user's profile indicates that availability of a discount coupon could influence him to buy something, the adaptive agent 102 then triggers an event that results in the coupon being sent to the user.

Spontaneous events 204C refer to events that arise without a predefined pattern or schedule, and are in contrast to periodic events 204A and scheduled events 204B. Spontaneous events 204C may be further classified as critical 204C-1 or non-critical 204C-2. Critical events 204C-1 demand or require an immediate action. Non-critical events 204C-2, by contrast, can be collected and processed with at least a slight delay. An example of a critical event 204C-1 would be when a medical patient monitoring system detects a serious deterioration in the vital signs of a patient and launches an event to notify medical personnel. An example of a non-critical event 204C-2 would be when a doctor receives a notification that a low-priority package has been delivered.

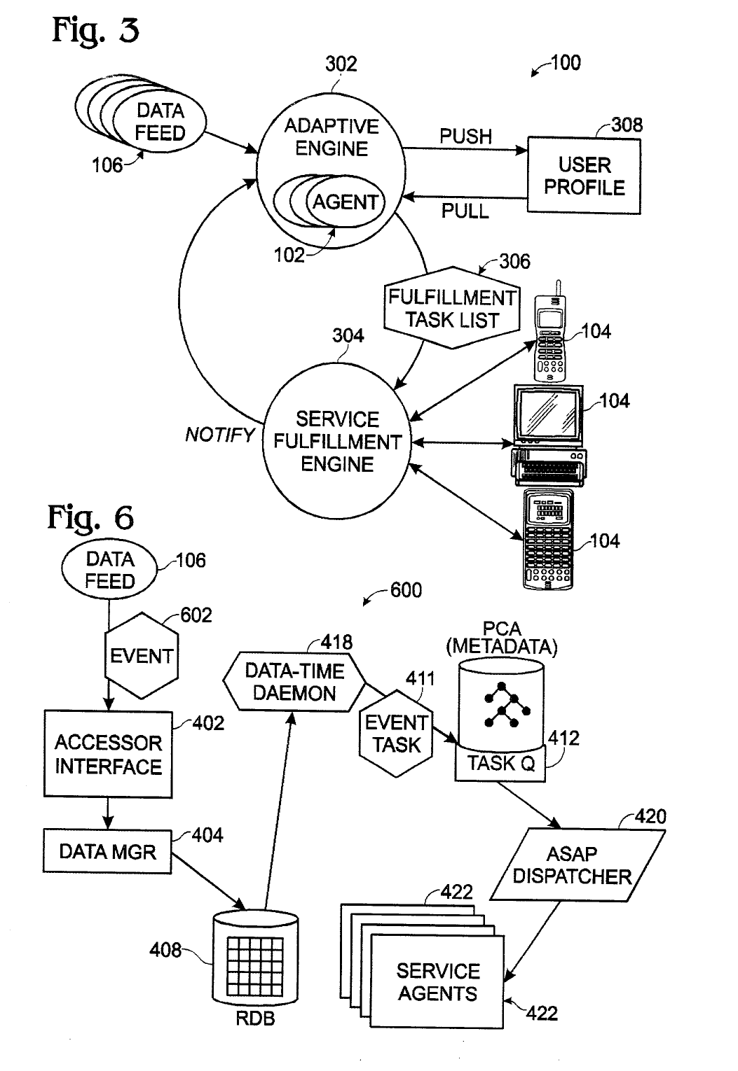

FIG. 3 is a block diagram generally illustrating an internal architecture of scalable agent service system 100, which includes an inferencing or reasoning portion referred to as an adaptive engine 302 and an action or event execution portion referred to as a service fulfillment engine 304. Adaptive engine 302 communicates with service fulfillment engine 304 via one or more fulfillment tasks 306 (sometimes referred to as one or more fulfillment task lists 306) that specify one or more actions to be fulfilled by service fulfillment engine 304. This permits adaptive engine 302 and service fulfillment engine 304 to asynchronously identify and process events and actions. In particular, adaptive engine 302 identifies and creates the fulfillment tasks 306 that need to be done, and service fulfillment engine 304 performs the actions required to complete the tasks.

Adaptive engine 302 includes various computer software agents that are instances of adaptive agents 102 and that provide detection of predefined events and correlation of them using predefined rules. Adaptive engine 302 may receive (pull) rules from or provide (push) correlated events to a store of user profiles 308.

As with conventional artificial intelligence (AI) techniques, adaptive agents 102 are typically implemented using so-called rules engines. Rule engines are fed a set of rules (of the form “if <condition(s)> then <consequence(s)>”) that embody the desired behavior of the adaptive agent 102. The rules are represented in the form of a consequent network inside the engine. When the engine fires, values, representing the parameters present in the rule conditions, are bound into the network and then the entire network is evaluated. For any rule where the conditions evaluate to TRUE, the corresponding consequence is executed. When the rules network finishes an execution, a set (possibly a null set) of fulfillment tasks 306 will have been spawned for execution. These fulfillment tasks 306 represent the set of consequences enabled by the rules.

The architecture of FIG. 3 partitions the reasoning or inferencing operation of adaptive engine 302 from the service fulfillment (action/execution) operation of service fulfillment engine 304. This partitioning allows the general artificial intelligence (AI) techniques or inferencing of adaptive engine 302 to operate independently of the distinct, possibly more mundane computational techniques (e.g., FTP to deliver a file, SMS messaging to a cell phone, etc.) for execution of fulfillment tasks 306 by service fulfillment engine 304. Scalable agent service system 100 can be generalized as having one or more adaptive engines 302 that each reasons about or operates on only certain kinds of events, and one or more service fulfillment engines 304 that each deals with or operates on only a specific kind of task or tasks.

Conventional architectural arrangements, such as instantiating and running a separate agent for each user of the system or having a single agent to serve all users, suffer from severe scalability limitations. In contrast, the architectural arrangement of adaptive engine 302 and service fulfillment engine 304 is scalable to large numbers of users (e.g., many thousands, or even millions). In particular, the partition between adaptive engine 302 and service fulfillment engine 304 allows them to operate simultaneously and illustrates two principles of configuring scalable systems to serve large numbers of users: the fission principle (“divide and conquer”) and the concurrency principle (“keep many balls in the air”).

The principle of fission means that a system should be partitioned into relatively small parts (components) that focus on carrying out some well-focused function. Good fission results in a system what can be split apart into subsystems capable of running separately. This leads to deployments that can leverage separate hardware platforms or simply separate processes or threadsthereby dispersing the load in the system and enabling various forms of load balancing and tuning.

The principle of concurrency means that there are many moving parts in the system. Activities are split across hardware, processes, and threads and are able to exploit the physical concurrency of modern SMPs (symmetric multiprocessors). Concurrency aids scalability by ensuring the maximum possible work is going on at all times and permitting system load to be addressed by spawning new resources on demand (within pre-defined limits).

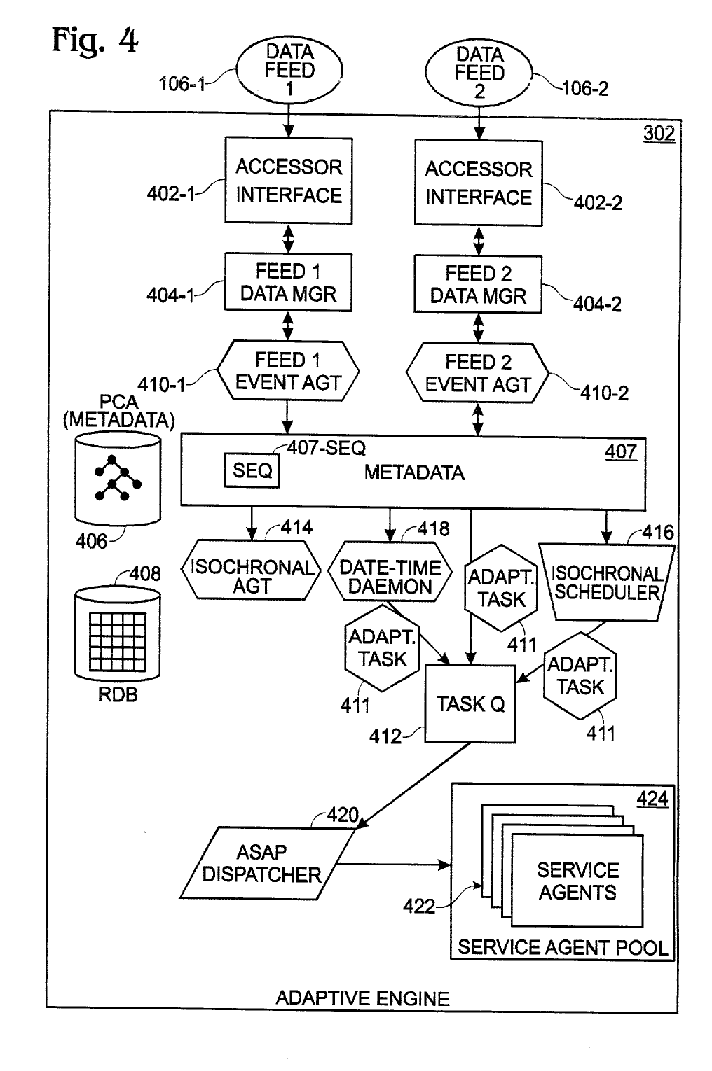

FIG. 4 is a block diagram of one implementation of an internal architecture of the adaptive engine 302. Adaptive engine 302 of FIG. 4 is described with reference to two data feeds 106-1 and 106-2, for example. It will be appreciated that adaptive engine 302 could generally operate with reference to an arbitrary number of data feeds 106.

Data feeds 106-1 and 106-2 are sources of external information or data that enters scalable agent service system 100 at adaptive engine 302. Data feeds 106-1 and 106-2 can be fed from any number of disparate sources. For example, a data feed 106-N might be a stock price feed from a commercial investment or news service or a physical device like a temperature sensor. (The reference numeral 106-N is a generalized reference to either or both of data feeds 106-1 and 106-2, or any other data feed.) Whatever the source, the external information or data received from data feeds 106-1 and 106-2 represents the raw “stimuli” that scalable agent service system 100 receives from the external environment.

Information from data feeds 106-1 and 106-2 is fed into a respective pair of accessor interfaces 402-1 and 402-2, which handle the actual details of how to interface to data in the feeds 106-1 and 106-2, such as error conditions, retries, and all the myriad details necessary to deal with the external world. Accordingly, accessor interfaces 402-1 and 402-2 are conventional, fairly mechanical software devices, as are known in the art. In the case of receiving information from a commercial service data feed, for example, the corresponding accessor interface 402-N would utilize whatever application programming interface (API) is provided by the commercial service vendor.

Each data feed 106-1/106-2 has its own uniquely suited accessor interface 402-1/402-2, respectively, and there may be multiple instances of a given accessor interface 402-N. For example, it might be necessary to partition an input for a data feed 106-N across multiple accessor interfaces 402-N if the data feed 106-N pushes or transfers large amounts of information into scalable agent service system 100. This ability to use multiple accessor interfaces 402-N for a data feed 106-N illustrates one aspect of the scalability of adaptive engine 302 and scalable agent service system 100.

Data received by accessor interfaces 402-1 and 402-2 is delivered to respective data managers 404-1 and 404-2. Each data manager 404-N is responsible for all the information or data from a corresponding data feed 106-N entering scalable agent service system 100. For example, a data manager 404-N may initiate a pull of data from the data feed 106-N (e.g., if the interface technology is not push-based). When it receives data from an accessor interface 402-N, a data manager 404-N performs any transformations (e.g., pulling specific parameters out of an XML document, changing metric units to English units, etc.) needed for persisting data in a relational database of record 408 or for persisting any metadata 407 in a metadata repository 406, such as a persistent or recoverable cache. As is known in the art, a database or other repository “of record” is deemed to be the authoritative information source when conflicting information arises.

Generally, scalable agent service system 100 utilizes two kinds of information: data of record and metadata 407. Data of record is persisted in relational database 408 and has an extended lifetime, such as user profiles 308. As another example, a user might create a scheduled event representing a doctor's appointment months in the future. Metadata 407, by contrast, has a relatively short lifetime and is persisted in metadata repository 406. Metadata 407 is information that has a short period of relevance (e.g., weather information) and is used to manage scalable agent service system 100 (e.g., isochronal tasks, as described below) or is used by agents to infer about events.

Event agents 410-1 and 410-2 are each an instance of a rules engine (indicated in FIG. 4 by a hexagon shape). Event agents 410-1 and 410-2 perform inferencing upon metadata 407 placed in a metadata repository 406 by data managers 404-1 and 404-2 to identify or correlate events and generate adaptive tasks 411 to be carried out in response to the event. For example, suppose an event agent 410-N is reasoning about weather and reads out of the metadata repository 406 metadata placed there by a weather data manager 404-N. The metadata indicates that the current weather conditions in Chicago are snow, 45 MPH winds, 200 feet visibility, and temperature 23 degrees F. The weather event agent 410-N infers that there is a winter storm in progress and decides what actions need to be taken as a result of the detection of this event. The weather event agent 410-N creates adaptive tasks 411 for these actions and places them in a task queue 412 for dispatch.

This operation of data managers 404-N and event agents 410-N illustrate an application of the principles of asynchronicity and independence characteristic of scalable systems. The principle of asynchronicity means that work can be carried out in the system on a resource-available basis. Contrast this with a system in which tasks need to be managed with cross-synchronization, which constrains a system under load because processes cannot be done out of order even if resources exist to do so. Asynchronocity decouples tasks and allows the system to schedule resources more freely and thus potentially more completely. This permits strategies to be implemented to more effectively deal with stress conditions like peak load.

The principle of independence (“keep it loose”) means that components in the systems are loosely coupled. Ideally, there is little or no dependence among components. This principle often (but not always) correlates strongly with asynchronicity. Highly asynchronous systems tend to be loosely coupled and vise versa. Loose coupling, or independence, means that components can pursue work without waiting on work from others. This also helps with strategies dealing with stress conditions.

Data managers 404-N place metadata in the metadata repository 406 independent of the operation of event agents 410-N. Event agents 410-N run and utilize this metadata in an asynchronous manner relative to the operation of data managers 404-N, and also create adaptive tasks 411 to be executed and run independently and asynchronously relative to each other. This permits several scaling options. For example, multiple event agents 410-N could run and inference about some subset of the metadata (e.g., there could be a Midwest weather agent and a Pacific Northwest weather agent).

Certain periodic events handled by scalable agent service system 100 are isochronal, meaning of “equal increments of time”. Consider the following example. A user of scalable agent service system 100 is about to take a flight for a business trip. He wants to be notified if the plane is going to be delayed so that he does not arrive at the airport and have an extended wait for the flight.

An isochronal agent 414 of scalable agent service system 100 checks flight metadata repeatedly at a preset time interval (e.g., every ten minutes) to see if the flight is running on time. In addition, an isochronal scheduling system 416 manages tasks that satisfy such periodic events, as described below in greater detail. One or more isochronal agents 414 are responsible for the creation and persistence of the metadata needed to ensure such events are properly scheduled. Isochronal scheduler 416 regularly scans this metadata and causes the tasks to be placed in task queue 412 for dispatch.

A date/time daemon 418 is responsible for ensuring that scheduled events occur in a timely fashion. Date/time daemon 418 periodically scans relational database 408 (e.g., every Δt minutes) looking for events that are scheduled during this time period. All events found by daemon 418 are converted to adaptive tasks 411 and placed on task queue 412 for dispatch. Alternatively, date/time daemon 418 could pass events that are found to isochronal scheduling system 416 to be mapped to a suitable time.

An ASAP dispatcher 420 and task queue 412 are responsible for causing the actual execution of adaptive tasks 411 to occur. ASAP dispatcher 420 removes an adaptive task 411 from queue 412, determines the kind of service agent 422 needed to execute the adaptive task 411, acquires such a service agent 422 from a service pool 424, and launches the service agent 422 with the adaptive task or tasks 411 on a separate thread. This is an example of the scalability principle of concurrency and so provides another opportunity to scale system 100. It is also possible to prioritize adaptive tasks 411 into a series of task queues 412 that have different priorities and are served by one or more dispatchers 420.

Service agents 422 are responsible for executing adaptive tasks 411 dispatched from task queue 412. Adaptive engine 302 will typically have multiple kinds of service agents 422 in an application, each capable of carrying out a specific type of adaptive task 411. Service agents 422 may or may not be intelligent agents (e.g., realized in a rules engine).

The nature of the task of each service agent 422 will determine the appropriate implementation technology. Often, but not necessarily always, the run of a service agent 422 will result in the creation of a fulfillment task 306 that is passed into the service fulfillment engine 304 for execution or an adaptive task 411 to be performed within adaptive engine 302. One implementation has all feed event agents 410-N, the date-time daemon service 418, and isochronal agent 414 implemented as instances of adaptive service agents 422 in the service agent pool 424.

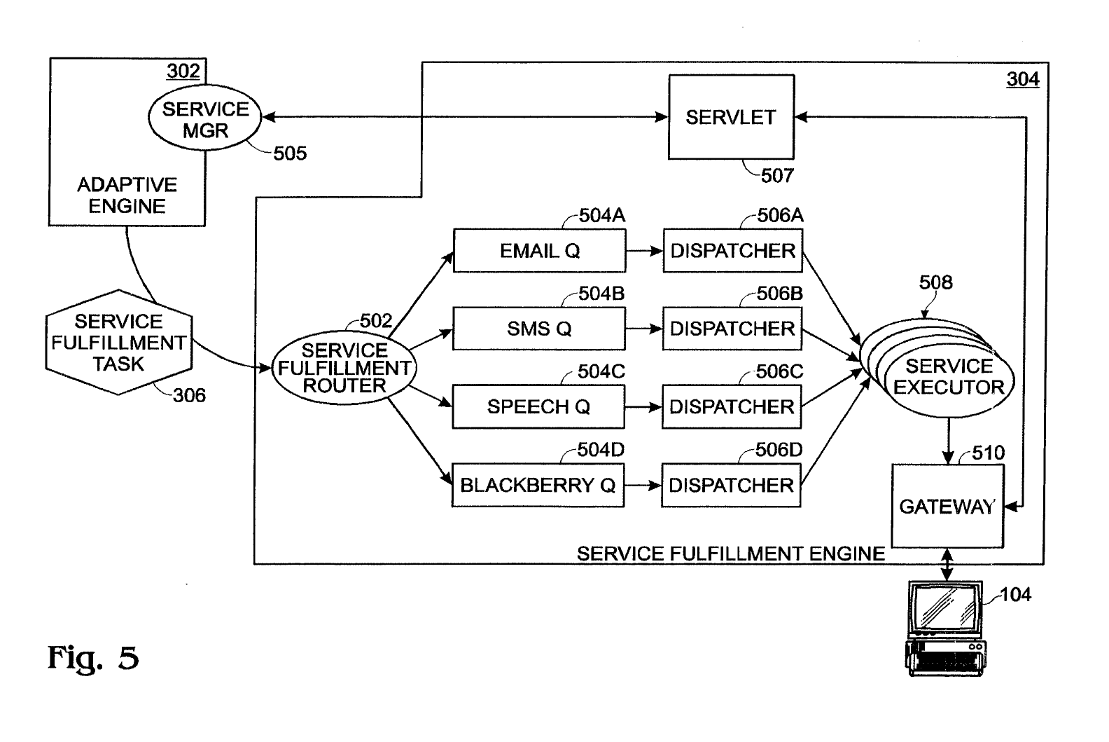

FIG. 5 is a block diagram of one implementation of an internal architecture of service fulfillment engine 304. A service fulfillment router 502 provides an external API to adaptive engine 302, such as via an enterprise java bean (EJB) technology. Adaptive engine 302 uses service fulfillment router 502 to cause fulfillment tasks 306 from adaptive engine 302 to be placed onto various task queues 504 for dispatch. A service manager 505 provides a bi-directional interface between adaptive engine 302 and a servlet 507 that services synchronous events 202, such as hypertext transfer protocol (http) calls, by passing tasks to and receiving results from adaptive engine 302 to be passed to a user.

Multiple service task queues 504 may be used depending on the technology or protocol to be used to send information to a system user. In this example, service fulfillment engine 304 is capable of delivering information via email (service task queues 504A), SMS messaging (e.g., delivered to a cellular telephone system) (service task queues 504B), voice messaging (service task queues 504C), or a Blackberry pager (service task queues 504D). Each queue 504 is managed by a corresponding dispatcher 506 that acquires a service executor 508 of the correct type and launches the executor 508 with the fulfillment task 306 on an execution thread of their own. The service executors 506, in turn, use the services of various gateways 510 to deliver their information to user computation devices or clients 104. The gateways 510 mask the protocol complexities of the various delivery technologies. They are responsible for guaranteeing message delivery and managing errors and retries.

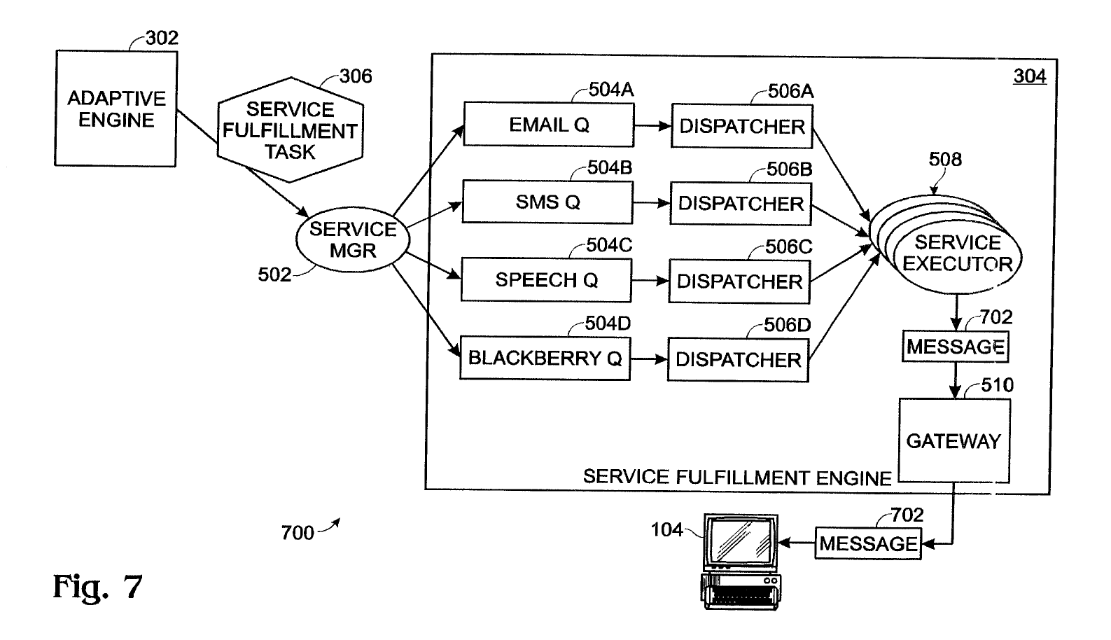

FIGS. 6 and 7 illustrate as process flows 600 and 700 operation of scalable agent service system 100 to service an exemplary scheduled event. A new scheduled event 602 enters scalable agent service system 100 via data feed 106 and passing through an accessor interface 402 to a data manager 404. The data manager 404 persists or stores the scheduled event 602 in the corresponding database of record 408.

At a later point in time (hours, days, months, . . . ), date-time daemon 418 on a scheduling run recognizes that the event is due and schedules delivery of a message by creating an adaptive task 411 and placing it on the task queue 412. The dispatcher 420 finds the adaptive task 411 on the queue 412, attaches the adaptive task 411 to the correct type of service agent 422, and fires a thread to execute the adaptive task 411.

Service agent 422 examines the adaptive task 411 and recognizes that it needs to queue a message delivery fulfillment task 306 with the service fulfillment engine 304. For example, service agent 422 queues the message delivery fulfillment task 306 by exercising a corresponding API of service manager 502 (FIG. 7). The API creates a message delivery fulfillment task 306 and places it in a corresponding messaging task queue 504. At a later point in time, a dispatcher 506 picks the fulfillment task 306 out of the queue 504, locates an appropriate service executor 508, and spawns a thread to run the executor 508 with the fulfillment task 306.

The executor 508 contacts the appropriate gateway 510 and uses its API to cause actual delivery of a message 702 to occur. After sending the message 702, the executor 508 returns to its pool and awaits another fulfillment task 306. Finally, message 702 regarding the scheduled event 602 arrives at the appropriate user computation device or client 104 and the user is informed of the event.

In the implementation described, the design calls for the separation of the adaptive engine 302 and service fulfillment engine 304. But a possible other implementation has the adaptive engine 302 and fulfillment engine 304 combined for the purpose of reusability, i.e. the task queue 412 the ASAP dispatcher 420 doubling as both adaptive and fulfillment task holders, and the adaptive agent pool 424 doubling as both adaptive and fulfillment service holders.

Set forth below is a description of the operation of scalable agent service system 100 with reference to another exemplary implementation to further illustrate lower-level operating details and techniques that support system scalability. This description references a mythical medical services company, “PatientTrack”, that maintains large patient databases for various medical enterprises that include many hospitals and clinics around the world.

In this illustration, PatientTrack not only administers and provides wide bandwidth access to the patient database, but also supports a workflow environment for keeping track of patient data such as requested tests and results, prescriptions, medication schedules, and patient status (e.g., vital sign statistics, current condition, etc.). PatientTrack decides to add value to its services by offering an agent service according to the present invention to provide relevant notifications for doctors and other medical professionals.

For this illustration, it is assumed that there are three basic types of service or event: patient condition change notification, current patient status notification, and calendar notification. Patient condition change notifications are always spontaneous, and current patient status notifications are always periodic. Calendar notifications support appointment events. In this illustration, all notifications are sent via telephone by way of an automated voice delivery mechanism.

When it is time for a subscriber (i.e., a doctor or other medical professional) to be notified, an event message is sent via SMS messaging and delivered to a previously registered telephone number. After the message is delivered, the subscriber has the opportunity to make new patient related arrangements using one of several mechanisms. For example, if a patient's condition deteriorates into a pre-set critical status, PatientTrack notifies all interested parties and permits them to modify the treatment of the patient by changing medications or their dosage and schedules, requesting new tests, etc. Subscribers can modify patient care over a computer network (e.g., the Internet) via WAP telephones, PDAs, or PCs.

Calendar notification events are created by subscribers. A subscriber can scan through all calendar messages on a per-day basis, or find a specific message using its day and time. Calendar notification operations include creating, deleting, or modifying an existing message.

PatientTrack also permits subscribers to request regular, periodic checks of the status of specific patients. If an event agent 410 detects a significant change in status during one of these checks, the subscriber is notified. The types of information tracked for a given patient can be individually chosen, but default information types can be selected and may include the patient's current vital sign statistics and latest test results. Doctors and other medical professionals are automatically registered for patient events relating to all patients under their care for a particular day, and can subscribe to information on other patients of interest. The subscriber can scan through the list of all patients he or she is subscribed for on a per day basis, or find a patient using the first few letters of the patient's last name. Operations include subscribing or un-subscribing to a particular patient's info, extending current subscriptions, turning on or off notifications (this does not remove subscriptions), and turning on or off automatic subscription. PatientTrack keeps preference information for all subscribers as a user profile 308 that is stored in relational database of record 408.

Scalability of agent service system 100 is necessary because PatientTrack is a worldwide operation and has tens of thousands, or more, subscribers to its notification services. Furthermore, if PatientTrack decides to make a subset of its services available to patient families, its subscriber number might increase into the hundreds of thousands, if not millions. Families might be entitled to have access to restricted patient status information (“still in surgery”, “currently sleeping”, current room number, current expected date of departure, etc.) using a temporary password. This service helps diminish the load on doctors, nurses, and hospitals' front desks. The immediate family can then distribute the password too, so that they, in turn, may subscribe to the restricted notification service.

With such a large number of subscribers, the scalability of the system 100 can be critical to providing the notification services with adequate performance and timeliness. The system 100 must scan through the data relating to all patients on a regular, periodic basis and inference to discover any events of interest. Additionally, if a critical spontaneous event occurs, this will also trigger a rules run over the relational database 408, as described below. Suppose PatientTrack has one million subscribers, is tracking 250,000 patients, must check on patients every 15 minutes, and must deliver any needed notifications for scheduled events in a timely fashion.

Partitioning

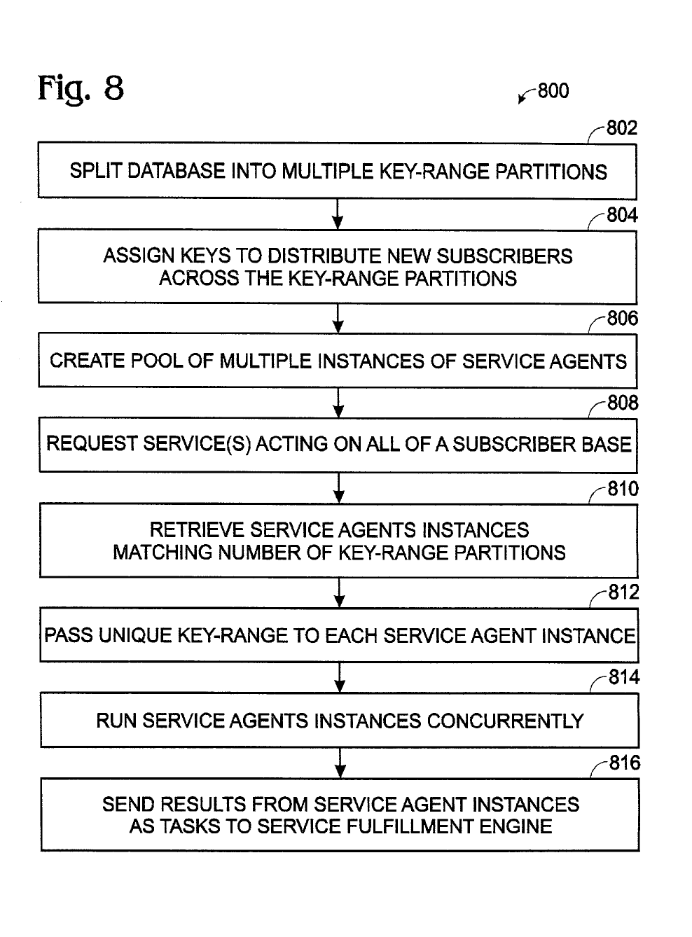

FIG. 8 is a flow diagram of a system partitioning method 800 that uses a combination of partitioning-for-concurrency and resource pooling to allow scalable agent service system 100 to apply a rules-based service to a very large database. Step 802 indicates that database 408 is broken or split into multiple key-range partitions. As is known in the art, a database includes keys that uniquely identify the tuples or records of the database. Step 804 indicates that keys are assigned to new subscribers at the time of their registration, the new subscribers being distributed generally evenly across the key-range partitions.

In accordance with steps 802 and 804, the key chosen for determining partition ranges should provide a good spread across partitions, such as in a round-robin fashion as new subscribers are registered. In some instances the primary key of database 408 will have this qualification. A primary key based on a serially created object and in which key insertion uses a modulo paradigm based on the number of partitions, for example, will prevent one partition from filling before new subscribers are added to the next partition.

Step 806 indicates that a pool 424 of multiple instances of service agents 422 is created, as illustrated in FIG. 4. Service agent pool 424 allows multiple threads of service agents 422 to operate concurrently.

Step 808 indicates that a request is made for one or more services that act on all of a subscriber base (i.e., with reference to all subscribers).

Step 810 indicates that N-number of instances of service agents 422 of the requested service are retrieved in correspondence with the database 408 having N-number of key-range partitions.

Step 812 indicates that a unique key-range is passed to each instance of service agent 422 as a tuple in an input data space, i.e. as one of the input arguments.

Step 814 indicates that all instances of service agents 422 are run concurrently over their respective key ranges.

Step 816 indicates that a result from each instance of each service agent 422 becomes a fulfillment task 306 that is sent to service fulfillment engine 304.

Since step 814 is directed to all partitions being accessed simultaneously, it is desirable that database 408 supports concurrent queries on the partitions, otherwise database queries will be serialized. Furthermore, it will be appreciated that the size, number, and definition rules for partitions supported by database 408 would be factored into choosing appropriate keys and ranges.

In accordance with step 810, the number of instances of service agent 422 of a certain type should be a multiple of the number of current partitions, so that one service request can be divided amongst concurrent instances of service agent 422. Many service requests can also be run concurrently, each request being handled in the manner described above.

In some implementations, the instances of service agent 422 in pool 424 may be dynamically adjusted as necessary to support any dynamic changes to the number of partitions in the subscriber table. The mechanics of creating dynamic 424 pools are well understood in the art. This approach permits the administrator of relational database 408 to fine-tune the partitions, or partition schema, for optimal performance. A new key-range choice may be dynamically reconfigured for optimal performance. In this manner access speed for relational database 408 (defined by the number of concurrent partition queries) and processing throughput (defined by the number of partitions, and thus number of instances of service agent 422 acting concurrently) may be matched.

For service agents 422 that are rule-based, the partition structure presented above offers particular added benefits. The partitioning of the subscriber space diminishes the size of the rule resolution space and speeds up the inference process.

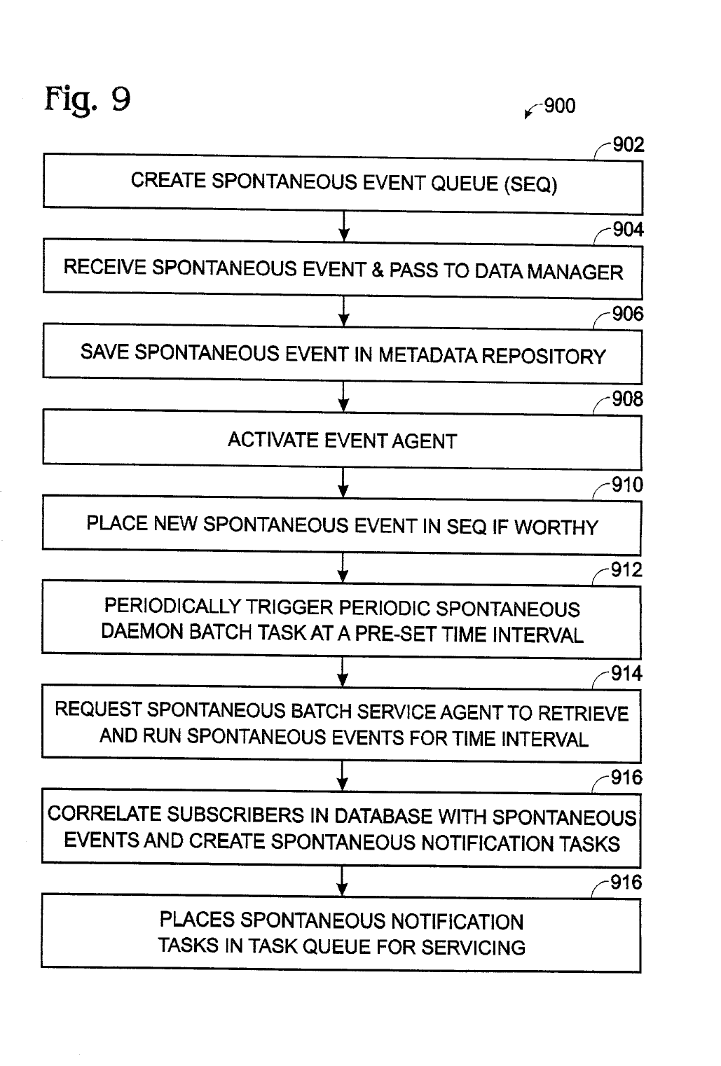

The partitioning method described above is well suited for handling strict deadline spontaneous events. The reason for not processing spontaneous events immediately is that it would prove expensive to query the whole database for every single event as it comes in. If the deadline constraint is slightly loosened, and events are permitted to wait a small amount before being sent as notification, then events can be batched for better performance. FIG. 9 is a flow diagram of a batched processing method 900 that utilizes these slightly relaxed constraints.

Step 902 indicates that an incoming spontaneous event queue (SEQ) 407-SEQ is created. Spontaneous event queue includes multiple queue slots that each contains an incoming spontaneous event.

Step 904 indicates that a spontaneous event is received (i.e., by adaptive engine 302) and passed to an appropriate data manager 404 for that event type (i.e., a data manager that is adapted to or “knows how to handle” the spontaneous event type). In one implementation, the spontaneous event is passed to the data manager 404 when the spontaneous event is first received by adaptive engine 302.

Step 906 indicates that the data manager 404 selectively saves the spontaneous event in the metadata repository 406.

Step 908 indicates that the data manager 404 activates an event agent 410 of the appropriate type.

Step 910 indicates that the new spontaneous event is placed in the spontaneous event queue (SEQ) 407-SEQ if deemed worthy of spontaneous handling. For example, the event agent 410 analyzes the new spontaneous event and decides if it is worthy of spontaneous notification, such as based upon predefined rules used by the event agent 410.

Step 912 indicates that a periodic spontaneous batch adaptive task 411 is triggered periodically from isochronal scheduling system 416 at a pre-set time interval. The spontaneous batch adaptive task 411 is delivered to task queue 412 to be dispatched by ASAP dispatcher 420.

Step 914 indicates that spontaneous batch adaptive task 411 requests that a spontaneous batch service agent 422 (SBS) pick-up or retrieve all queued spontaneous events for that time interval and run the whole batch through database 408.

Step 916 indicates that spontaneous batch service agent 422 correlates subscribers in relational database 408 with spontaneous events of interest, and a spontaneous notification adaptive task 411 is created for each correlated subscriber or a single task might be created to server multiple subscribers depending on implementation choices.

Step 918 indicates that spontaneous batch service agent 422 places all spontaneous notification adaptive tasks 411 in the task queue 412 of ASAP dispatcher 420 for servicing.

The notification immediacy required of a spontaneous emergency event can be met by system partitioning method 800, but not batched processing method 900. In the PatientTrack illustration, if a patient's condition deteriorates into a life-and-death situation, no doctor would appreciate receiving a message from PatientTrack fifteen minutes after the fact in accordance with the periodic status report interval.

Accordingly, one implementation of scalable agent service system 100 provides different categories of spontaneous events deadline requirements. For example, an implementation of scalable agent service system 100 can provide two categories of spontaneous event deadline requirements: Critical (utilizing system partitioning method 800) and Non-critical (utilizing batched processing method 900). Critical spontaneous events would always be sent as notification at arrival time. Non-critical events could be sent a few minutes after arrival time. In support of multiple spontaneous event categories, ASAP dispatcher 420 may include queuing that permits the corresponding different levels of priority for servicing tasks.

Batching Work

Spontaneous events 204C can be critical (204C-1) or non-critical (204C-2). Critical spontaneous events 204C-1 need to be serviced immediately and, of necessity, trigger a service agent 422 to do a rules run against relational database 408. However, non-critical spontaneous events 204C-2 can be handled in a less costly manner. When a non-critical spontaneous event 204C-2 occurs, it can be aggregated with other such events. Then a service agent 422 on its regular periodic run can evaluate the batch of non-critical spontaneous events 204C-2 against subscribers and take the appropriate actions. After a period a time, non-critical spontaneous events 204C-2 are removed from the aggregation since all subscribers have been evaluated against the events. Batching the work needed to service non-critical spontaneous events 204C-2 reduces the total number of rules runs needed and enhances system scalability.

Isochronal Mapping

Periodic events can be difficult to handle efficiently in a large-scale system. One option is to query an entire subscriber database at every time period AT (e.g., every minute) to identify the periodic tasks to be carried out for that time period. Such frequent database queries would be computationally very expensive. In the worst case, such queries would be in vain when no subscribers need notification for that time period.

An alternative option would be to create a calendar with a minute-by-minute representation of each day over a period of months, and filling the minute time slots with lists of appointment and periodic events to be serviced. This approach would be wasteful of storage and computation resources and difficult to maintain. Periodic events are, by definition, the same requests repeated over and over at equidistant time intervals, and it would be wasteful to specify the same request as multiple separate time-of-day entries. Furthermore, any appointment or periodic event rearrangements (i.e. additions, deletions and modifications) could require extensive table manipulations, possibly for many days or even months.

An embodiment of the present invention provides scheduling operations in accordance with three mechanisms: ASAP dispatcher 420 dispatches at the current time adaptive tasks 411 included in a task queue 412, isochronal scheduling system 416 schedules periodic adaptive tasks 411 and moves them into task queue 412 of ASAP dispatcher 420 at each current time segment, and a calendar table that is stored in an appointment database of record 408 schedules appointment adaptive tasks 411 that may be passed to isochronal scheduling system 416 for scheduling (if sufficient lead time is available) or passed directly placed the task queue 412 of ASAP dispatcher 420 if immediately dispatch is appropriate. Hence, these scheduling operations can use two separate event tables: one containing pre-computed periodic events that are handled by isochronal scheduling system 416 and another containing non-periodic scheduled events, i.e. calendar appointments.

Periodic Events: Isochronal Mapping

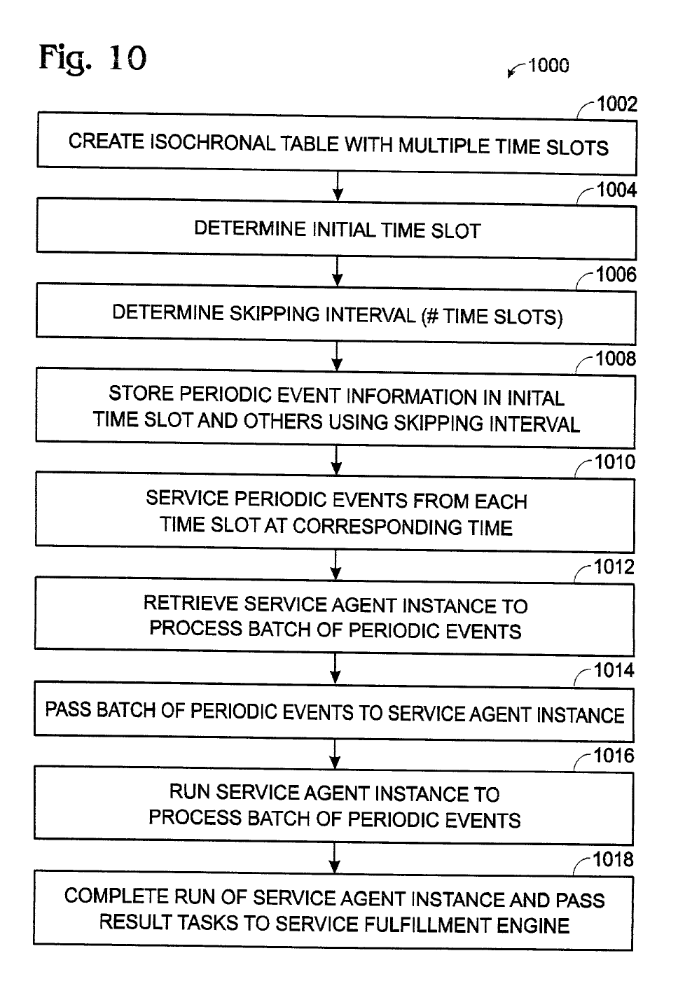

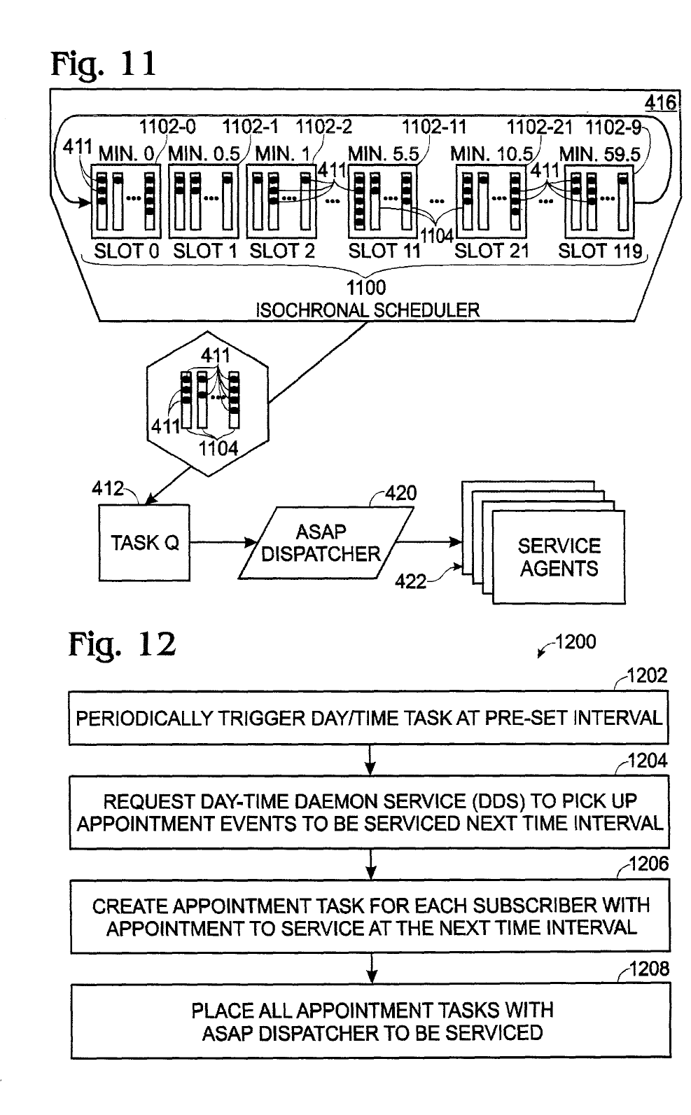

Isochronal scheduling system 416 employs a circular buffer that is responsible for administering pre-computed periodic events. FIG. 10 is a flow diagram of an isochronal scheduling method 1000 used by isochronal scheduling system 416 to manage periodic event tasks and is described with reference to an isochronal table or map 1100 that is schematically illustrated in FIG. 11.

Step 1002 indicates that an isochronal table 1100 is created and includes multiple time slots 1102 that represent equidistant intervals (e.g., every minutes) within a recurring time period (e.g., one hour or 24 hours). Time slots 1102 are referred to as the basic intervals of table 1100. Each time slot 1102 contains one or more sets or batches 1104 of periodic event tasks 41 1 to be serviced. This batching of adaptive tasks facilitates concurrent processing.

The following steps 1004-1008 are performed for each subscriber-registered periodic event.

Step 1004 indicates that a registration time of day (i.e., a time when a periodic service is to begin) is mapped into an initial time slot 1102 in isochronal table 1100.

Step 1006 indicates that a periodic interval (i.e., a time before servicing a periodic event again) is mapped into a number of time slots 1102 in isochronal table 1100.

Step 1008 indicates that periodic event tasks 411 are stored in time slots 1102 in isochronal table 1100, starting with a time slot 1102 for the registration time of day (step 1004), and using the number of time slots 1102 determined in step 1006 as a skipping interval (i.e., time period or slots between one filled slot and the next). Placing or storing a periodic event in a time slot 1102 entails mapping the periodic event to an appropriate batch where the event is then queued.

Step 1010 indicates that the periodic event tasks 411 from each time slot 1102 are serviced at a time corresponding to the time slot 1102. For example, each periodic event batch 1104 for a current time slot 1102 is sent from isochronal scheduling system 416 via ASAP dispatcher 420 to a matching service agent 422 for processing.

Step 1012 indicates that at least one instance of service agent 422 of the appropriate type is retrieved to process the batch 1104 of periodic event tasks 411. In one implementation, the at least one instance of service agent 422 of the appropriate type may be retrieved from a pool 424 of multiple available instances.

Step 1014 indicates that the batch 1104 of periodic event tasks 411 is passed to the at least one instance of service agent 422. If multiple instances of service agent 422 of the appropriate type are retrieved, a subset of the batch 1104 of periodic event tasks 411 is passed to each instance.

Step 1016 indicates that the at least one instance of service agent 422 is run to process the batch 1104 of periodic event tasks 411. If multiple instances of service agent 422 of the appropriate type are retrieved, all instances are run concurrently over their respective batch subsets.

Step 1018 indicates that the run of the at least one instance of service agent 422 is completed and results are passed as fulfillment tasks 306 to service fulfillment engine 304.

Isochronal Mapping

Isochronal scheduling method 1000 uses a circular or recurring buffer or map 1100 of a relatively brief period (e.g., one hour or 24 hours) that receives and stores periodic event tasks 411 for that time period. The isochronal map 1100 is repeatedly reloaded with periodic event tasks 411 for a next time period as the periodic event tasks 411 for a current time period are processed. For example, slots 1102-0,1102-1, and 1102-2 may be reloaded with periodic event tasks 411 for a next time period while periodic event tasks 411 from other slots are being processed (e.g., slots 80-82, or any other slots depending on system timing and avoidance of interference between slot operations). Moreover, it will be appreciated that isochronal scheduling method 1000 may be applied to “perpetual” periodic event tasks 411 for which there is no fixed or scheduled termination of the repetition of the tasks, or to “temporary” periodic event tasks 411 for which there is a fixed or scheduled termination of the repetition of the tasks.

The number of multiple time slots 1102 established in step 1002 defines a frequency at which, or the times when, isochronal scheduler 416 is activated. With an interval ΔTS (in seconds) between runs of isochronal scheduler 416, then the number NS of time slots 1102 in the isochronal map 1100 will be 3600/ΔTS per hour in the map times the number of hours represented in the map. The number NS of time slots 1102 defines a spread of periodic event servicing, i.e. how often tasks are sent from isochronal table or map 1100 to ASAP dispatcher 420. For example, for an interval ΔTS=30 (i.e., 30 seconds), the number of slots is NS=3600/30=120 per hour.

Step 1008 includes a conversion of the registration time of day into an initial slot 1102, and the conversion depends on the number NS of time slots 1102 and correspondingly on the interval ΔTS. Greater numbers of time slots 1102 (i.e., smaller time interval ΔTS) introduce smaller quantization errors in the conversion. The initial slot number is the minute:second-component of the registration time of day converted into seconds, then divided by ΔTS, then truncated to the closest integer.

For example, assuming an isochronal map of size equivalent to one hour, if Doctor Lutz registers at 10:32:15 AM (in hour:minute:second format) to get periodic notification on a patient's status, then the minute:second-component is 32:15, or 1935 seconds. Assuming ΔTS=30, then the first slot for this periodic event will be truncated (1935/30), which equals 64. Optionally a selection could be made between truncation or rounding-off, depending on the remainder of the division. Generally, such precision would not be necessary.

The periodic interval, or time between periodic notifications, in step 1006 can be mapped into a number of time slots 1102 in isochronal table 1100 using the formula NS*ATP/3600, where ATP is the periodic interval in seconds. For example, for Doctor Lutz to receive information on the status of his patient every 15 minutes, or 900 seconds, the periodic interval could be calculated as 120*900/3600, or 30 time slots.

The above illustrations relating to Doctor Lutz may be summarized as follows: an interval between time slots 1102 of ΔTS=30, a number NS of time slots being 120, Doctor Lutz registers to get periodic notifications beginning with time slot 64 and periodically every 15 minutes (i.e., every 30 time slots). Under these exemplary conditions, periodic event “tokens” are placed in time slots numbered 64 (first slot), 94 ((first slot+skip) modulo NS), 4 ((second slot+skip) modulo NS), and 34 ((third slot+skip) modulo NS) for scheduling successive 4 periodic notifications.

Appointment Events

In one implementation, appointment events are serviced once at a particular day/time combination. FIG. 12 is a flow diagram of an appointment management method 1200 for managing appointment events.

Step 1202 indicates that a periodic day/time appointment task is triggered from isochronal scheduling system 416 periodically at a pre-set interval.

Step 1204 indicates that the day/time appointment task gets dispatched into the adaptive service agent pool 424 that in turns starts a Day-Time Daemon Service (DDS) 418. The DDS 418 picks up from appointment database of record 408 all appointment events that need to be serviced within a next time interval. For example, the DDS 418 directs a query to the appointment database of record 408 to obtain the appointment events.

Step 1206 indicates that the DDS 418 creates an appointment adaptive task 411 for each subscriber that needs to have appointments serviced at the next time interval.

Step 1208 indicates that all appointment tasks are placed in the ASAP dispatcher 420 to be serviced. Optionally, the appointment tasks may be placed in the isochronal system 416 for more accurate delivery time spread.

All event types share a common timing mechanism. The isochronal mechanisms described above are used for each of the three types of asynchronous events. Periodic events 204A are triggered directly to start services. Appointment events 204B and non-critical spontaneous events 204C-2 are triggered indirectly by way of periodic daemon services. In addition, task queue 412 of ASAP dispatcher 420 is used consistently for all event types. Periodic events 204A and critical spontaneous events 204C-1 go directly into ASAP dispatcher 420 for servicing. Non-critical spontaneous events 204C-2 and appointment events 204B go indirectly into the queue 412 of ASAP dispatcher 420 queue by way of a daemon adaptive task 411, which in turn directly uses the ASAP queue 412.

Generally, the isochronal mechanisms (e.g., isochronal scheduler 416) represent a future time space, and ASAP dispatcher 420 represents a current or now space. That is, isochronal scheduler 416 is associated with some future interval ΔT, where ΔT>0, and ASAP dispatcher 420 is associated to a space where ΔT=0. All time-interval scheduling in system 100 is a responsibility of isochronal scheduler 416, and all dispatching concerns for what needs to be done at a current moment are a responsibility of ASAP dispatcher 420. Consequently, all time in system 100 may converted into space adhering to a single, consistent and complete paradigm. The pre-computation of time intervals by mapping into isochronal slots, and the eventual queuing into the ASAP “now” space does much to reduce the processing load and improve performance of system 100.

More specifically, scheduling deadline requirements are met because isochronal scheduler 416 does not block execution since adaptive tasks 411 are simply queued into ASAP dispatcher 420. Scalable throughput can be achieved because multiple instances of ASAP dispatcher 420 may be created to handle increased loads. Traffic (Input/Output) to relational database 408 is reduced since services do not have to scan relational database 408 looking to find out subscribers interested in particular times of the day. Instead, subscribers are correlated to times of the day of interest by way of the isochronal scheduler 416.

Scalable agent service system 100 incorporates various principles of scalable systems and so is capable of significant scalability. Options for scaling system 100 in deployment include:

spawning more agents (i.e., agent threads)

spawning more executors (i.e., executor threads)

partitioning subsystems

adding platforms

shortening the schedule interval of isochronal scheduler 416

adding additional instances of ASAP dispatcher 420 managing different priority queues

changing the partitioning parameters of relational database 408

partitioning subsystems onto separate physical platforms

partitioning users into different systems

by geography

by user ID

etc.

Additionally, scalable agent service system 100 accommodates change. New data feeds 106 may be easily integrated by adding new accessor interfaces 402 and data managers 404. New services can be accommodated or provided by adding corresponding new service agent 422. Changed parameters and standards can be implemented by editing agent rules while the underlying software can remain unchanged. This kind of flexibility results in a system that can evolve gracefully over time to meet the needs its users.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A scalable agent service scheduling method that supports plural computer software agents to perform tasks for plural client computation devices, the method comprising:
obtaining an isochronal table of plural activation times over a recurring time period at which periodic tasks can be activated, the isochronal table including a predefined time interval between each of the successive activation times;
characterizing each periodic task as including an initial task and one or more successive tasks to be activated periodically, the initial task having an initial event time;
applying the initial event time of the initial task of each periodic task to a corresponding activation time in the isochronal table;
determining a skipping interval representing a number of activation times in the isochronal table corresponding to the period at which each of the one or more successive tasks of a periodic task are to be activated periodically;
storing at activation times determined by the skipping interval the one or more successive tasks of each periodic task to be activated periodically; and
passing as one or more batches the tasks for each activation time for processing by one or more computer software event agents when the activation time occurs.

2. The method of claim 1 further comprising queuing independently from the isochronal table the tasks that are passed as a batch for each activation time for processing.

3. The method of claim 1 further comprising providing selected non-periodic spontaneous tasks to plural client computation devices at respective ones of the activation times.

4. The method of claim 3 in which the selected non-periodic spontaneous tasks correspond to spontaneous events that are suitable for receiving delayed processing according to a predefined rule and are distinguished from spontaneous tasks that require immediate processing according to the predefined rule.

5. The method of claim 3 further comprising queuing independently from the isochronal table the selected non-periodic spontaneous tasks that are performed for the plural client computation devices at the respective ones of the activation times.

6. The method of claim 1 further comprising providing pre-scheduled non-periodic appointment tasks to plural client computation devices at respective ones of the activation times.

7. The method of claim 6 further comprising queuing independently from the isochronal table the pre-scheduled non-periodic appointment tasks that are performed for the plural client computation devices at the respective ones of the activation times.

8. The method of claim 1 in which the recurring time period of the isochronal table is one hour.

9. The method of claim 1 in which the recurring time period of the isochronal table is 24 hours.

10. In a computer readable medium, scalable agent task scheduling software that supports plural computer software agents for performing tasks for plural client computation devices, comprising:
software for obtaining an isochronal table of plural activation times over a recurring time period at which periodic tasks can be activated, the isochronal table including a predefined time interval between each of the successive activation times;
software for characterizing each periodic task as including an initial task and one or more successive tasks to be activated periodically, the initial task having an initial event time;
software for applying the initial event time of the initial task of each periodic task to a corresponding activation time in the isochronal table;
software for determining a skipping interval representing a number of activation times in the isochronal table corresponding to the period at which each of the one or more successive tasks of a periodic task are to be activated periodically;
software for storing at activation times determined by the skipping interval the one or more successive tasks of each periodic task to be activated periodically; and
software for passing as one or more batches tasks for each activation time for processing by one or more computer software event agents when the activation time occurs.

11. The medium of claim 10 further comprising software for queuing independently from the isochronal table the tasks that are passed as a batch for each activation time for processing.

12. The medium of claim 10 further comprising software for performing selected non-periodic spontaneous tasks for plural client computation devices at respective ones of the activation times.

13. The medium of claim 10 further comprising software for performing pre-scheduled non-periodic appointment tasks for plural client computation devices at respective ones of the activation times.

14. The medium of claim 10 in which the recurring time period of the isochronal table is one hour.

15. The medium of claim 10 in which the recurring time period of the isochronal table is 24 hours.

16. A scalable agent service scheduling system that supports plural computer software service agents for providing services to plural client computation devices, the comprising:
an isochronal scheduler of future event services, the isochronal scheduler including an isochronal table of plural activation times at which service events can be activated, the isochronal table including a predefined time interval between each of the successive activation times, the isochronal scheduler passing as a batch all service events for each activation time to a service event queue; and
a dispatcher of current service events for retrieving them from the service event queue and acquiring and launching service agents to service the service events.

17. The system of claim 16 in which the isochronal scheduler passes service events to the service event queue asynchronously with the dispatcher retrieving the service events from the service event queue.

18. The system of claim 16 in which the future event services include periodic services and the system further comprises a computer readable medium having stored thereon:
software for characterizing each periodic service as including an initial service event and one or more successive service events to be activated periodically, the initial service event having an initial event time;
software for applying the initial event time of the initial service event of each periodic service to a corresponding activation time in the isochronal table;
software for determining a skipping interval representing a number of activation times in the isochronal table corresponding to the period at which each of the one or more successive service events of a periodic service are to be activated periodically; and
software for storing at activation times determined by the skipping interval the one or more successive service events of each periodic service to be activated periodically.

19. The system of claim 18 further comprising software for providing selected non-periodic spontaneous services to plural client computation devices at respective ones of the activation times.

20. The system of claim 19 in which the selected non-periodic spontaneous services correspond to spontaneous events that are suitable for receiving delayed processing according to a predefined rule and are distinguished from spontaneous events that require immediate processing according to the predefined rule.

21. The system of claim 18 further comprising software for providing pre-scheduled non-periodic appointment services to plural client computation devices at respective ones of the activation times.
